(19) United States
(12) Patent Application Publication
(10) Pub. No.: US 2015/0199648 A1
(43) Pub. Date: Jul. 16, 2015

(54) INFORMATION PROCESSING SYSTEM, INFORMATION PROCESSING DEVICE, AND INFORMATION PROCESSING METHOD

(71) Applicant: Yuichi YOMOGIDA, Kanagawa (JP)

(72) Inventor: Yuichi YOMOGIDA, Kanagawa (JP)

(21) Appl. No.: 14/593,510

(22) Filed: Jan. 9, 2015

(30) Foreign Application Priority Data
Jan. 14, 2014 (JP) 2014-004284
Dec. 17, 2014 (JP) 2014-255574

(51) Int. Cl. G06Q 10/10

(52) U.S. Cl. CPC G06Q 10/1091

(57) ABSTRACT

An information processing system includes an identification information acquisition unit configured to acquire identification information for identifying a user; a retaining unit configured to retain pieces of identification information for identifying users previously registered; an authentication unit configured to authenticate the identified user when the pieces of identification information retained in the retaining unit include the identification information acquired; a controller configured to register attendance information in which the identification information of the authenticated user and time information indicating an authentication time are associated with each other when the user is authenticated; a delay information acquisition unit configured to acquire delay information including delay time information indicating a delay time from a delay certificate; and a modification unit configured to modify, based on modification information in which the identification information of the authenticated user and the delay information are associated with each other, the time information.

### CROSS-REFERENCE TO RELATED APPLICATIONS

The present application claims priority to and incorporates by reference the entire contents of Japanese Patent Application No. 2014-004284 filed in Japan on Jan. 14, 2014 and Japanese Patent Application No. 2014-255574 filed in Japan on Dec. 17, 2014.

### BACKGROUND OF THE INVENTION

1. Field of the Invention

The present invention relates to an information processing system, an information processing device, and an information processing method.

2. Description of the Related Art

In a small-scale office with a small number of employees, there is a need to perform attendance management without introducing a time recorder (dedicated device for attendance management). As a system that responds to this need, there is known an attendant management system in which a time recorder function is implemented in an MFP (Multifunction Peripheral) that can read an employee ID from an IC card.

In this system, when working time is modified by reason of, e.g., delay of a public transportation facility (railway, bus, or the like), a user (employee) needs to acquire a delay certificate from the public transportation facility and input modification information to the system.

For example, Japanese Laid-open Patent Publication No. 2007-034820 discloses a system including an abnormal section information management unit that retains information such as an abnormality occurrence route and the like, a usage section information recording unit that records therein usage section information, a unit that reads the usage section information, and a determination unit that determines whether or not an accident is one where a passenger cannot arrive at a destination station at the final arrival time owing to the abnormality based on the final arrival time for the passenger to arrive at the destination station to go to work without delay, the usage section information, and the abnormal section information.

However, conventionally, there is no system that records arrival time/leaving time while automatically reflecting delay of the transportation facility that the user uses.

Therefore, there is a need to provide an information processing system, an information processing device, and an information processing method, capable of recording arrival time/leaving time while automatically reflecting delay of the transportation facility that the user uses.

### SUMMARY OF THE INVENTION

It is an object of the present invention to at least partially solve the problems in the conventional technology.

According to an embodiment, there is provided an information processing system that includes an information processing device; and a server device configured to retain information related to attendance/leaving of a user. The information processing system also includes an identification information acquisition unit configured to acquire identification information for identifying the user; a first retaining unit configured to retain one or more pieces of identification information for identifying users previously registered; an authentication unit configured to authenticate the user identified by the identification information acquired by the identification information acquisition unit when the pieces of identification information retained in the first retaining unit include the identification information acquired by the identification information acquisition unit; a registration controller configured to register attendance information in which the identification information of the authenticated user and time information indicating an authentication time are associated with each other when the user is authenticated by the authentication unit; a delay information acquisition unit configured to read out information of a delay certificate according to an instruction from the authenticated user to acquire delay information including delay time information indicating a delay time; and a modification unit configured to modify, based on modification information in which the identification information of the authenticated user and the delay information are associated with each other, the time information included in the attendance information corresponding to the identification information included in the modification information.

According to another embodiment, there is provided an information processing device that includes an identification information acquisition unit configured to acquire identification information for identifying a user; a first retaining unit configured to retain one or more pieces of identification information for identifying users previously registered; an authentication unit configured to authenticate the user identified by the identification information acquired by the identification information acquisition unit when the pieces of identification information retained in the first retaining unit include the identification information acquired by the identification information acquisition unit; a first controller configured to transmit, when the user is authenticated by the authentication unit, to a server device that retains information related to attendance/leaving of the user, attendance information in which the identification information of the authenticated user and time information indicating an authentication time are associated with each other; a delay information acquisition unit configured to read out information of a delay certificate according to an instruction from the authenticated user to acquire delay information including delay time information indicating a delay time; and a second controller configured to transmit, to the server device, modification information in which the identification information of the authenticated user and the delay information are associated with each other.

According to still another embodiment, there is provided an information processing method executed by an information processing device. The information processing method includes acquiring identification information for identifying a user; authenticating the user identified by the identification information when one or more pieces of identification information for identifying users previously registered include the identification information acquired at the acquiring, the pieces of identification information being retained in a first retaining unit; transmitting, when the user is authenticated at the authenticating, to a server device that retains information related to attendance/leaving of the user, attendance information in which the identification information of the authenticated user and time information indicating an authentication time are associated with each other; reading out information of a delay certificate according to an instruction from the authenticated user to acquire delay information including delay time information indicating a delay time; and transmitting, to the server device, modification information in which the identification information of the authenticated user and the delay information are associated with each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating a configuration example of an information processing system according to an embodiment;

FIG. 2 is a view illustrating an example of a hardware configuration of an MFP;

FIG. 3 is an exemplary view illustrating a software configuration of the MFP;

FIG. 4 is a view illustrating an example of a functional configuration of the MFP;

FIG. 5 is a view illustrating a functional configuration of an attendance management server;

FIG. 6 is a view illustrating an example of information stored in an attendance information storage unit;

FIG. 7 is a view illustrating an example of information retained by a second retaining unit;

FIG. 8 is a sequence diagram illustrating an example of an operation procedure of the information processing system;

FIG. 9 is a view illustrating an example of a delay certificate;

FIG. 10 is a view illustrating an example of information displayed on an operation panel;

FIG. 11 is a view illustrating an example of information stored in an attendance information storage unit after modification;

FIG. 12 is a view illustrating an example of a functional configuration of the MFP according to a modification;

FIG. 13 is a view illustrating an example of a functional configuration of the MFP according to another modification; and

FIG. 14 is a sequence diagram illustrating an example of an operation procedure of the information processing system according to the other modification.

### DETAILED DESCRIPTION OF THE PREFERRED EMBODIMENTS

Hereinafter, with reference to the accompanying drawings, an information processing system, an information processing device, and an information processing method and program according to the present invention will be described in detail based on an embodiment.

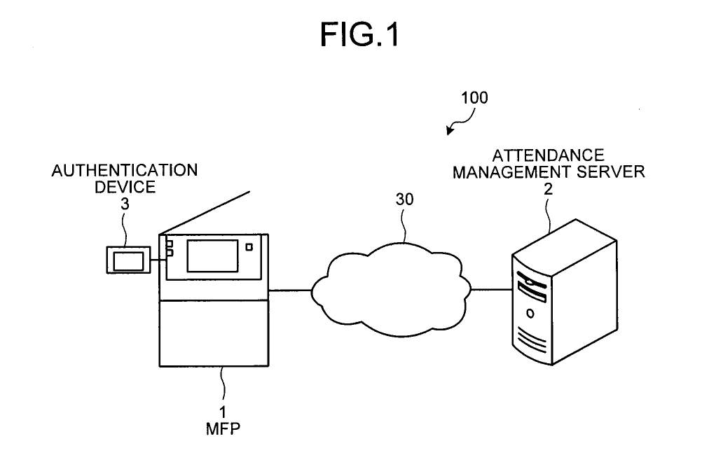

As illustrated in FIG. 1, an information processing system 100 according to the present embodiment includes an MFP 1 and an attendance management server 2. The MFP 1 and attendance management server 2 are connected to each other through a network 30 such as the Internet.

The MFP 1 is a device, which may be referred to as an information processing device, having various functions such as a copy function, a scanner function, a facsimile function, and a printer function. The MFP 1 is connected with an authentication device 3. The authentication device 3 is realized by an IC card reader in the present embodiment, but not limited thereto. For example, when a user brings an IC card in which identification information for identifying the user is recorded close to (holds the IC card over) the authentication device 3, the authentication device 3 reads the identification information recorded in the IC card. In the present embodiment, the IC card reader as the authentication device 3 may be a non-contact type or a contact type and can utilize various known configurations. The attendance management server 2 is a device that retains information related to attendance and leaving of a user.

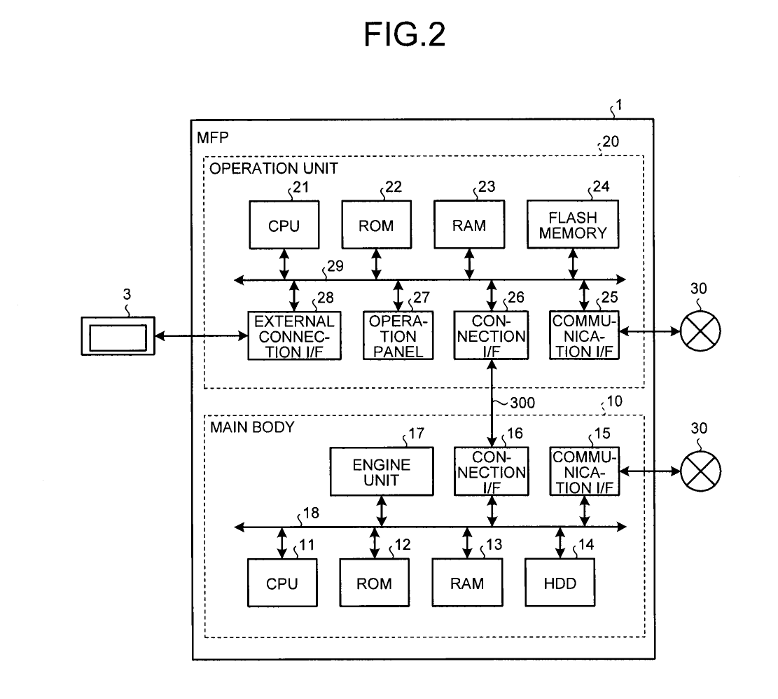

The following describes a hardware configuration of the MFP 1 using FIG. 2. As illustrated in FIG. 2, the MFP 1 includes a main body 10 capable of realizing various functions such as the copy, scanner, facsimile, and printer functions and an operation unit 20 that receives a user's operation. To receive the user's operation is a concept including reception of information (including a signal or the like indicating a coordinate value on a screen) input in response to the user's operation. The main body 10 and operation unit 20 are communicably connected to each other through a dedicated communication channel 300. The communication channel 300 may be a communication channel of a USB (Universal Serial Bus) standard, but may be of any standard, irrespective of wired or wireless.

The main body 10 can perform operation according to the user's operation received by the operation unit 20. Further, the main body 10 can communicate with an external device such as a client PC (Personal Computer) and can also perform operation according to an instruction received from the external device.

First, a hardware configuration of the main body 10 will be described. As illustrated in FIG. 2, the main body 10 includes a CPU 11, a ROM 12, a RAM 13, an HDD (Hard Disk Drive) 14, a communication I/F (interface) 15, a connection I/F 16, and an engine unit 17, which are connected to each other through a system bus 18.

The CPU 11 totally controls operation of the main body 10. The CPU 11 executes a program stored in the ROM 12 or HDD 14 using the RAM 13 as a work area to thereby control the operation of the main body 10, allowing the above-mentioned various functions such as the copy, scanner, facsimile, and printer functions to be realized.

The communication I/F 15 is an interface for connecting to the network 30. The connection I/F 16 is an interface for communicating with the operation unit 20 through the communication channel 300.

The engine unit 17 is a hardware that performs processing other than general-purpose information processing and communication processing, that is, performs processing for realizing the copy, scanner, facsimile, and printer functions. The engine unit 17 includes, e.g., a scanner (image reading unit) that scans and reads out an image on a document, a plotter (image forming unit) that performs printing with respect to a sheet material such as a paper, and a facsimile unit that performs facsimile communication. The engine unit 17 may further include a specific option such as a finisher for sorting the printed sheet material or an ADF (Automatic Document Feeder) for automatically feeding a document.

The following describes a hardware configuration of the operation unit 20. As illustrated in FIG. 2, the operation unit 20 includes a CPU 21, a ROM 22, a RAM 23, a flash memory 24, a communication I/F 25, a connection I/F 26, an operation panel 27, and an external connection I/F 28, which are connected to each other through a system bus 29.

The CPU 21 totally controls operation of the operation unit 20. The CPU 21 executes a program stored in the ROM 22 or flash memory 24 using the RAM 23 as a work area to thereby control the operation of the operation unit 20, allowing the various functions to be described later, such as display of information (image) according to an input received from a user, to be realized.

The communication I/F 25 is an interface for connecting to the network 30. The connection I/F 26 is an interface for communicating with the main body 10 through the communication channel 300.

The operation panel 27 receives various inputs according to user's operation and displays various information (information according to the received operation, information indicating an operating state of the MFP 1, information indicating a setting state, etc.). In this example, the operation panel 27 is realized by a liquid crystal display (LCD) with a touch panel function, but not limited thereto, and may be realized by an organic EL display with a touch panel function. Further, in addition to or in place of this, an operation unit such as hardware keys or a display unit such as a lamp may be provided.

The external connection I/F 28 is an interface for connecting to the above-mentioned authentication device 3.

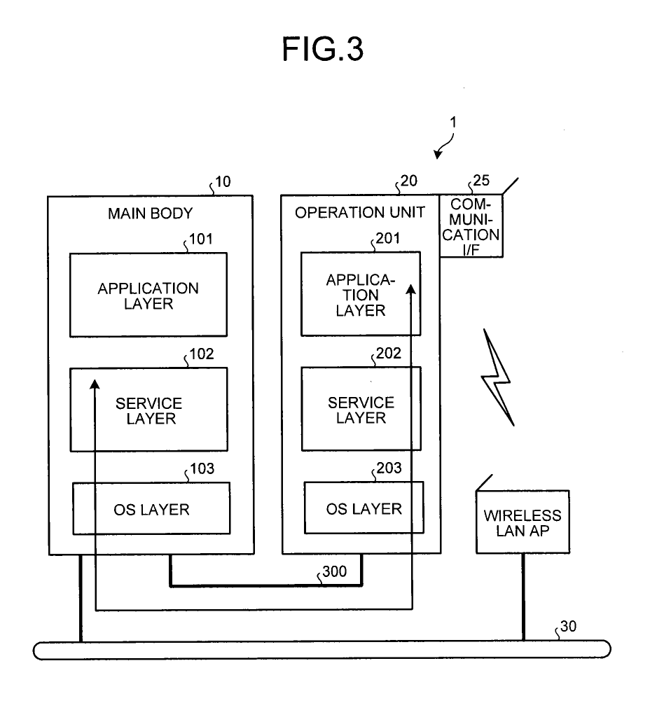

The following describes a software configuration of the MFP 1. FIG. 3 is an exemplary view illustrating an example of a software configuration of the MFP 1. As illustrated in FIG. 3, the main body 10 includes an application layer 101, a service layer 102, and an OS layer 103. Entities of the application layer 101, service layer 102, and OS layer 103 are various types of software which are stored in the ROM 12, the HDD 14, or the like. The CPU 11 executes these various types of software to thereby provide various functions.

Software on the application layer 101 is application software (hereinafter, sometimes referred to merely as “application”) for activating a hardware resource to provide a predetermined function. Examples of the application include a copy application for providing a copy function, a scanner application for providing a scanner function, a facsimile application for providing a facsimile function, and a printer application for providing a printer function.

Software on the service layer 102 is interposed between the application layer 101 and OS layer 103 and provides an interface for the application to use a hardware resource that the main body 10 has. More specifically, the software on the service layer 102 is software that provides a function of receiving an operation request for the hardware resource and arbitrating the operation request. The operation request that the service layer 102 receives includes reading operation for the scanner, printing operation for the plotter, and the like.

The function of the interface by the service layer 102 is provided not only for the application layer 101 of the main body 10 but also for an application layer 201 of the operation unit 20. That is, the application layer 201 (application) of the operation unit 20 can also achieve the function using the hardware resource (e.g., engine unit 17) of the main body 10 through the interface function of the service layer 102.

Software on the OS layer is basic software (operating system) for providing a basic function for controlling hardware that the main body 10 has. The software on the service layer 102 converts a hardware resource use request from various applications into a command that the OS layer 103 can interpret and passes the resultant command to the OS layer 103. Then, the software on the OS layer 103 executes this command and, thereby, the hardware resource performs operation according to the request from the application.

Similarly, the operation unit 20 includes an application layer 201, a service layer 202, and an OS layer 203. A hierarchical structure among the application layer 201, service layer 202, and OS layer 203 of the operation unit 20 is the same as that of the main body 10; however, a function provided by an application on the application layer 201 and an operation request that the service layer 202 can receive differ from those of the main body 10. The application on the application layer 201 may be software that activates a hardware resource of the operation unit 20 to provide a predetermined function, but mainly provides an UI (User Interface) function for performing operation or display regarding the functions (copy function, scanner function, facsimile function, and printer function) of the main body 10.

In the present embodiment, to maintain independence of the function, the software on the OS layer 103 of the main body 10 and software on the OS layer 203 of the operation unit 20 are made to differ from each other. That is, the main body 10 and operation unit 20 operate independently of each other on different operating systems. For example, it is possible to use Linux® as the software on the OS layer 103 of the main body 10 and to use Android® as the software on the OS layer 203 of the operation unit 20.

As described above, in the MFP 1 of the present embodiment, the main body 10 and operation unit 20 operate on the different operating systems, so that communication between the main body 10 and operation unit 20 is performed not as an inter-process communication within a single device but as communication between different devices. An operation (command communication) of transmitting information (instruction from a user) that the operation unit 20 receives to the main body 10, an operation in which the main body 10 notifies the operation unit 20 of an event, or the like corresponds to this. The operation unit 20 performs the command communication with the main body 10 and can thereby use the function of the main body 10. Examples of the event notified from the main body 10 to the operation unit 20 include, e.g., an operation execution state in the main body 10, contents set in the main body 10, and the like.

Further, in the present embodiment, power is supplied to the operation unit 20 from the main body 10 through the communication channel 300, so that it is possible to perform power control for the operation unit 20 independently of power control for the main body 10.

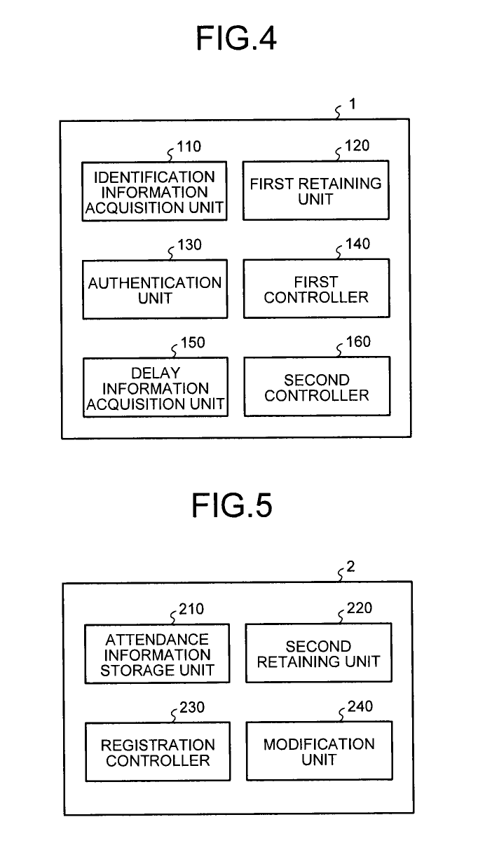

The following describes a functional configuration of the MFP 1. FIG. 4 is a block diagram illustrating an example of a functional configuration of the MFP 1. As illustrated in FIG. 4, the MFP 1 includes an identification information acquisition unit 110, a first retaining unit 120, an authentication unit 130, a first controller 140, a delay information acquisition unit 150, and a second controller 160. Although, in FIG. 4, mainly the functions according to the present embodiment are exemplified for descriptive convenience, the functions that the MFP 1 has are not limited to these.

The identification information acquisition unit 110 has a function of acquiring, from the authentication device 3, identification information for identifying a user. The first retaining unit 120 retains previously registered one or more pieces of identification information. For example, a system administrator can register, for each user who has an authority for using the MFP 1, the identification information for identifying the user in the first retaining unit 120 in advance.

The authentication unit 130 has a function of performing authentication processing by determining whether or not there exists, among one or more pieces of identification information retained in the first retaining unit 120, identification information coinciding with the identification information acquired by the identification information acquisition unit 110. When there exists, among one or more pieces of identification information retained in the first retaining unit 120, the identification information acquired by the identification information acquisition unit 110, the authentication unit 130 authenticates a user identified by the identification information acquired by the identification information acquisition unit 110.

The first controller 140 performs, when the user is authenticated by the authentication unit 130, control to transmit, to the attendance management server 2, attendance information associating at least the identification information of the authenticated user and time information indicating an authentication time. In the present embodiment, when the user is authenticated by the authentication unit 130, the first controller 140 performs control to display, on the operation panel 27, an attendance/leaving screen that prompts the user to select attendance or leaving. The user (user who holds the IC card over the authentication device 3) who views the attendance/leaving screen displayed on the operation panel 27 performs operation (e.g., operation of touching an attendance button or a leaving button displayed on the screen) of selecting attendance or leaving. As a result, selection information indicating attendance or leaving is input. Upon receiving the selection information, the first controller 140 performs control to transmit, to the attendance management server 2, the attendance information associating the identification information of the authenticated user, time information indicating the authentication time, and the received selection information.

In short, when the user is authenticated by the authentication unit 130, it is only necessary for the first controller 140 to perform control to transmit, to the attendance management server 2, the attendance information associating at least the identification information of the authenticated user and time information indicating an authentication time.

The delay information acquisition unit 150 reads out, according to an instruction from the authenticated user, information of a delay certificate issued from a transportation facility that the user uses to thereby acquire delay information including at least delay time information indicating a delay time. More specifically, the delay information acquisition unit 150 performs control to scan the delay certificate by using the above-mentioned scanner function to thereby acquire the delay information. In the present embodiment, the delay information includes information (hereinafter, sometimes referred to as “second transportation facility information”) indicating delayed transportation facility, the specific content of which will be described later.

The second controller 160 performs control to transmit, to the attendance management server 2, modification information associating the identification information of the authenticated user and delay information acquired by the delay information acquisition unit 150, specific content of which will be described using a sequence diagram to be described later.

The above-described functions (identification information acquisition unit 110, authentication unit 130, first controller 140, delay information acquisition unit 150, and second controller 160) of the MFP 1 are realized by the CPU (11 or 21) executing a program stored in a storage device (e.g., ROM 12, HDD 14, ROM 22, or flash memory 24); alternatively, however, at least some of the functions of the MFP 1 may be realized by a dedicated hardware circuit (e.g., semiconductor integrated circuit). Further, the first retaining unit 120 may be realized by the HDD 14 or the like of the main body 10 or by the flash memory 24 or the like of the operation unit 20.

The following describes a functional configuration of the attendance management server 2. FIG. 5 is a block diagram illustrating a functional configuration of the attendance management server 2. In this example, the attendance management server 2 includes an attendance information storage unit 210, a second retaining unit 220, a registration controller 230, and a modification unit 240. Although, in FIG. 5, mainly the functions according to the present embodiment are exemplified for descriptive convenience, the functions that the attendance management server 2 has are not limited to these.

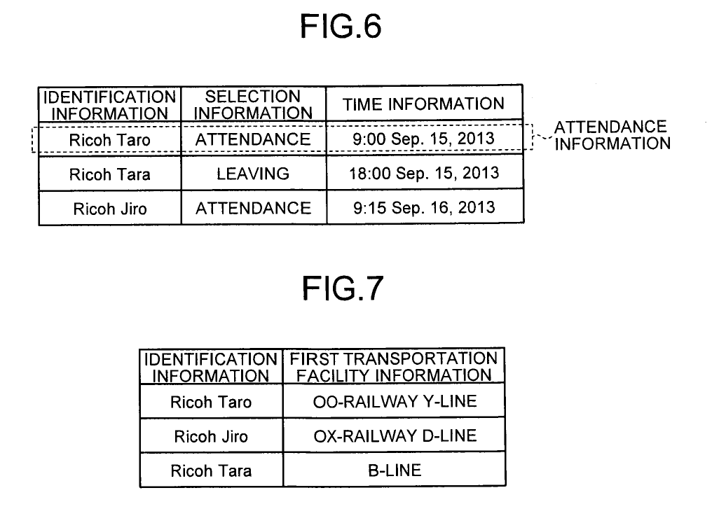

The attendance information storage unit 210 stores one or more pieces of attendance information. FIG. 6 is a view illustrating an example of information stored in the attendance information storage unit 210. In the example of FIG. 6, the attendance information storage unit 210 stores three attendance information.

In the example of FIG. 6, attendance information of a first row is attendance information associating identification information indicating “Ricoh Taro”, selection information indicating “attendance”, and time information indicating “9:00 a.m. Sep. 15, 2013”, which indicates that a user identified by the identification information “Ricoh Taro” “attended” the office at “9:00 a.m. Sep. 15, 2013”. Further, attendance information of a second row is attendance information associating identification information indicating “Ricoh Tara”, selection information indicating “leaving”, and time information indicating “18:00 p.m. Sep. 15, 2013”, which indicates that a user identified by the identification information “Ricoh Tara” “left” the office at “18:00 p.m. Sep. 15, 2013”. Furthermore, attendance information of a third row is attendance information associating identification information indicating “Ricoh Jiro”, selection information indicating “attendance”, and time information indicating “9:15 a.m. Sep. 16, 2013”, which indicates that a user identified by the identification information “Ricoh Jiro” “attended” the office at “9:15 a.m. Sep. 16, 2013”.

The description is continued referring back to FIG. 5. The second retaining unit 220 retains, for each piece of identification information, information (hereinafter, sometimes referred to as “first transportation facility information”) indicating the transportation facility that a user identified by the identification information in an associated manner. In this example, the first transportation facility information associated with the identification information is previously registered by, e.g., a system administrator. A function (setting unit) of variably setting (changing) the first transportation facility information registered in the second retaining unit 220 may be provided.

FIG. 7 is a view illustrating an example of information retained by the second retaining unit 220. In the example of FIG. 7, the identification information indicating “Ricoh Taro” and first transportation facility information indicating “OO-Railway Y-line” are associated with each other, which indicates that the user identified by the identification information “Ricoh Taro” uses “OO-Railway Y-line” as the transportation facility. Further, in the example of FIG. 7, the identification information indicating “Ricoh Jiro” and first transportation facility information indicating “OX-Railway D-line” are associated with each other, which indicates that the user identified by the identification information “Ricoh Jiro” uses “OX-Railway D-line” as the transportation facility. Further, in the example of FIG. 7, the identification information indicating “Ricoh Tara” and first transportation facility information indicating “B-line” are associated with each other, which indicates that the user identified by the identification information “Ricoh Tara” uses “B-line” as the transportation facility.

The description is continued referring back to FIG. 5. The registration controller 230 receives the above attendance information from the MFP 1 and performs control to register the received attendance information in the attendance information storage unit 210. Receiving the attendance information from the MFP 1 can be regarded to be equivalent to success of the user authentication made by the authentication unit 130. That is, it can be also considered that when the user is authenticated by the authentication unit 130, the registration controller 230 performs control to register, in the attendance information storage unit 210, attendance information associating at least the identification information of the authenticated user and time information indicating the authentication time in the attendance information storage unit 210.

The modification unit 240 receives the above modification information from the MFP 1 and modifies, based on the received modification information, the time information included in the attendance information corresponding to the identification information included in the modification information, the specific content of which will be described using a sequence diagram to be described later.

In the present embodiment, the attendance management server 2 is realized by a computer device including a CPU, a storage device such as a ROM or RAM, and a communication I/F for communicating with the MFP 1, and the above-described functions (registration controller 230 and modification unit 240) of the attendance management server 2 are realized by the CPU executing a program stored in the storage device; alternatively, however, at least some of the functions (registration controller 230 and modification unit 240) of the attendance management server 2 may be realized by a dedicated hardware circuit (e.g., semiconductor integrated circuit). Further, the attendance information storage unit 210 and second retaining unit 220 may be realized by the ROM, an external storage device (HDD, etc.) or the like. Further, the attendance information storage unit 210 and second retaining unit 220 may be realized by different storage devices or by a single storage device.

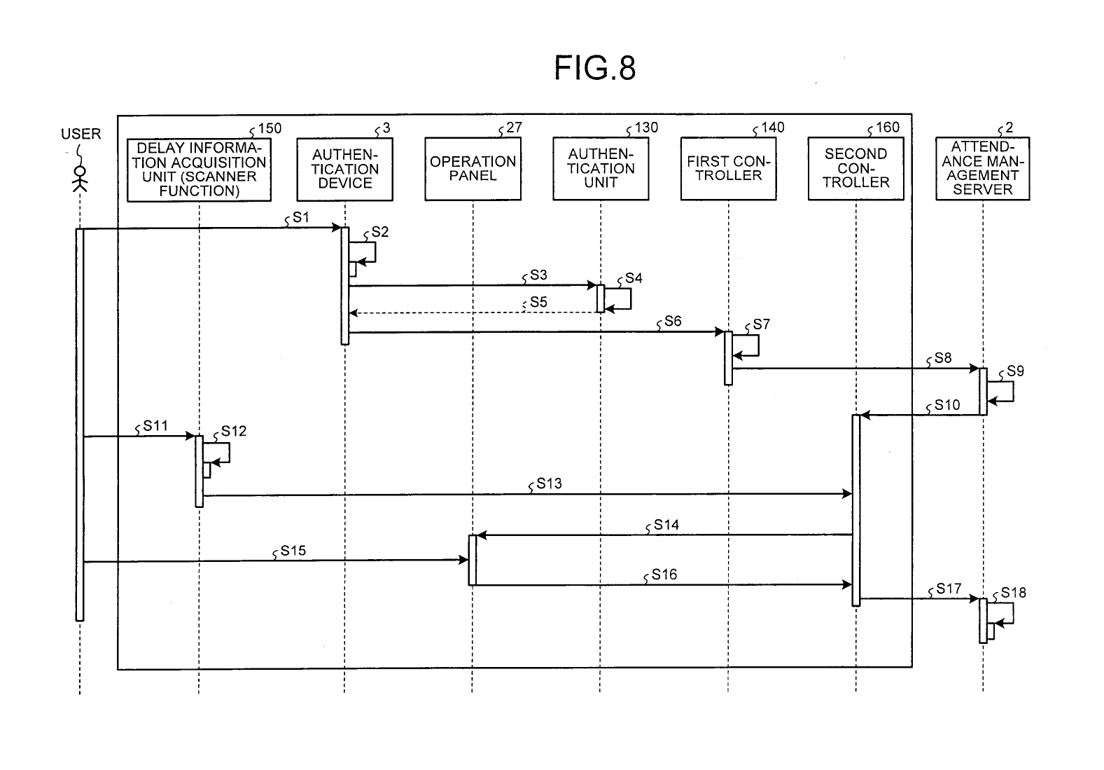

FIG. 8 is a sequence diagram illustrating an example of an operation procedure of the information processing system 100. First, a user holds his or her IC card over the authentication device 3 (step S1). The authentication device 3 reads out the identification information (identification information for identifying the user) recorded in the IC card (step S2), and the identification information acquisition unit 110 acquires the identification information read out by the authentication device 3. Subsequently, the identification information acquisition unit 110 passes the acquired identification information to the authentication unit 130 (step S3).

The authentication unit 130 performs authentication processing by determining whether or not there exists, among one or more pieces of identification information retained in the first retaining unit 120, identification information passed from the identification information acquisition unit 110 (step S4). When there exists, among one or more pieces of identification information retained in the first retaining unit 120, the identification information passed from the identification information acquisition unit 110, the authentication unit 130 authenticates the user identified by the identification information passed from the identification information acquisition unit 110 and notifies the authentication device 3 of success of the user authentication (step S5).

The authentication device 3 that receives the notification of success of the user authentication requests the first controller 140 to transmit the attendance information to the attendance management server 2 (step S6). Upon reception of the request, the first controller 140 generates the attendance information (step S7). More specifically, as described above, the first controller 140 performs control to display the attendance/leaving screen on the operation panel 27. The user (authenticated user) who views the attendance/leaving screen displayed on the operation panel 27 selects “attendance” or “leaving”. As a result, selection information indicating “attendance” or “leaving” is input. Upon receiving the selection information, the first controller 140 generates the attendance information associating the identification information of the authenticated user, time information indicating the authentication time, and the received selection information. Then, the first controller 140 performs control to transmit the generated attendance information to the attendance management server 2 (step S8).

The attendance management server 2 registers the attendance information received from the first controller 140 (step S9). Then, the attendance management server 2 identifies, from among the first transportation facility information previously registered in the second retaining unit 220, the first transportation facility information associated with the identification information included in the attendance information received in step S9, associates the identified first transportation facility information and identification information (identification information included in the attendance information received in step S9) which is associated with the identified first transportation facility information with each other, and notifies the second controller 160 of the resultant information (step S10).

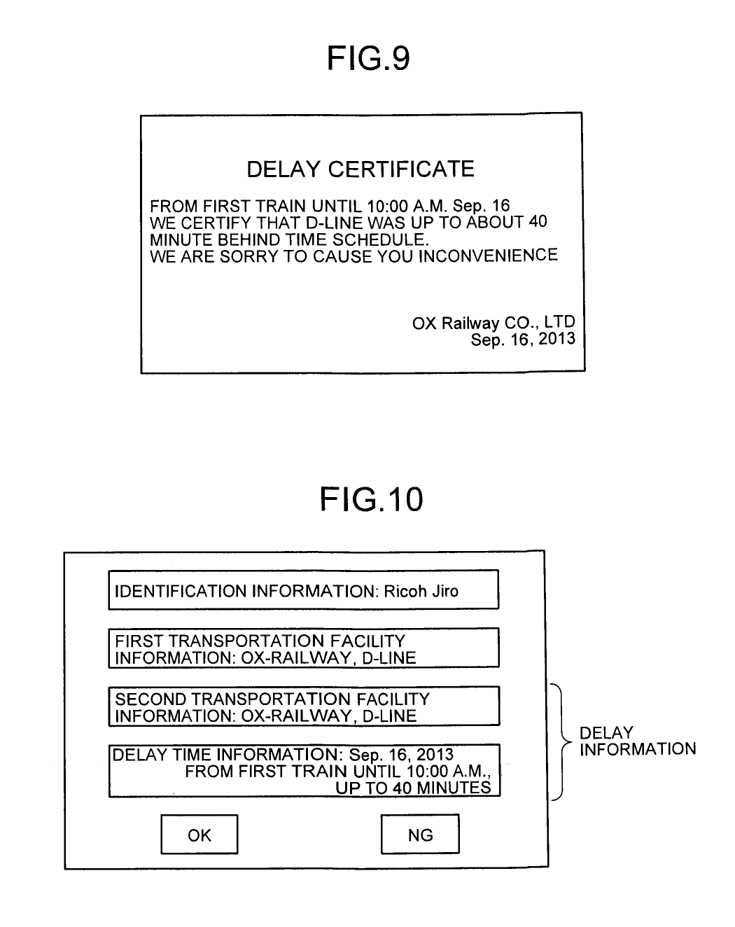

Then, the authenticated user operates the operation panel 27 to instruct reading out of a delay certificate acquired in a station or the like (step S11). FIG. 9 is a view illustrating an example of the delay certificate. Upon receiving the above instruction, the delay information acquisition unit 150 reads out information of the delay certificate to thereby acquire delay information including the delay time information (in the example of FIG. 9, the delay time information indicates that a train was up to about 40 minutes behind the time schedule during a time period from a departure time of the first train until 10:00 a.m. September 16) indicating delay time and second transportation facility information (in the example of FIG. 9, Denentoshi-line) indicating a delayed transportation facility (step S12).

Then, the delay information acquisition unit 150 requests the second controller 160 to display the delay information acquired in step S12 on the operation panel 27 (step S13). Upon receiving the request, the second controller 160 requests the operation panel 27 to display the identification information and first transportation facility information which are notified from the attendance management server 2 in step S10 and information (delay information) of which display is requested from the delay information acquisition unit 150 (step S14).

The operation panel 27 then displays the identification information and first transportation facility information notified from the attendance management server 2 to the second controller 160 and delay information acquired by the delay information acquisition unit 150 (step S15). From a different point of view, it can be considered that the second controller 160 has a function of performing control to display the delay information acquired by the delay information acquisition unit 150 on the operation panel 27. The second controller 160 may be referred to as a display controller. Alternatively, a function that performs control to display the delay information on the operation panel 27 corresponding to a display unit may be provided separately from the second controller 160.

FIG. 10 is a view illustrating an example of information displayed on the operation panel 27 in step S15. The authenticated user checks whether or not a transportation facility indicated by the displayed first transportation facility information coincides with a transportation facility (transportation facility indicated by the first transportation facility information previously registered in association with the user's own identification information) that the user uses or whether or not the displayed identification information coincides with the user's own identification information. When the determination result indicates coincidence, the user depresses an UI button of “OK” in FIG. 10 (step S15). Upon receiving the depression of the UI button of “OK”, the operation panel 27 notifies the second controller 160 of depression of the UI button of “OK” (step S16). Upon receiving the notification, the second controller 160 performs control to transmit, to the attendance management server 2, modification information associating the identification information of the authenticated user and delay information acquired by the delay information acquisition unit 150 (step S17).

Upon receiving the modification information from the MFP 1, the attendance management server 2 modifies, based on the received modification information, the time information included in the attendance information corresponding to the identification information included in the received modification information (step S18). More specifically, the modification unit 240 identifies, from among the one or more pieces of attendance information stored in the attendance information storage unit 210, the attendance information including the identification information included in the modification information received from the MFP 1. Then, the modification unit 240 modifies, based on the delay information included in the modification information received from the MFP 1, the time information included in the identified attendance information.

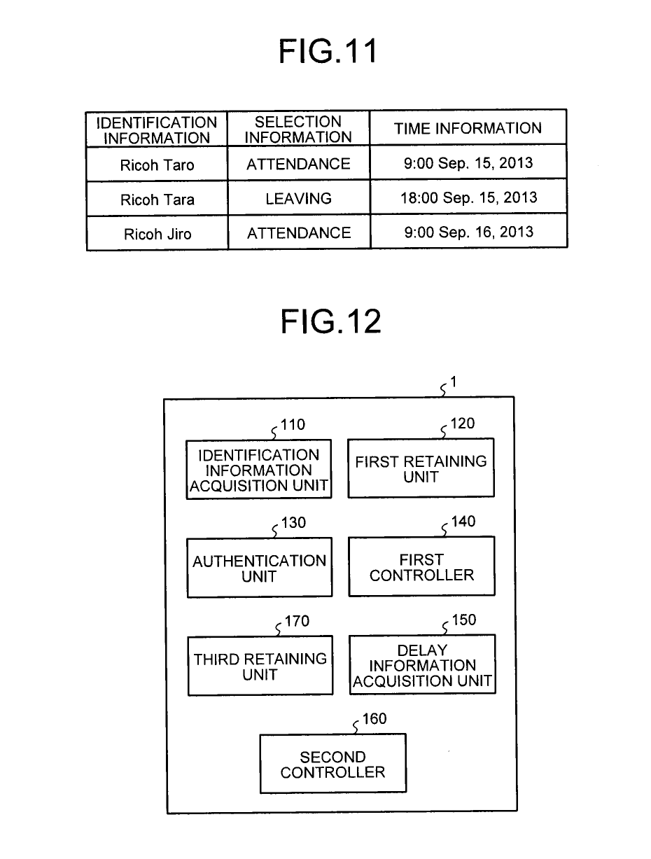

Here, it is assumed that FIG. 6 represents information that is stored in the attendance information storage unit 210 before modification made in step S18 and that the modification information received from the MFP 1 in step S18 includes the identification information indicating “Ricoh Jiro” and delay information of FIG. 10. Further, it is assumed that working start time is “9:00 a.m.”. In this case, the time information associated with the identification information indicating “Ricoh Jiro” before modification represents “9:15 a.m. Sep. 16, 2013”, while the delay time information included in the delay information of FIG. 10 represents that a delay of up to about 40 minutes has occurred during a time period from a departure time of the first train until 10:00 a.m. Sep. 16, 2013. That is, if the delay had not occurred in the transportation facility, it would be determined that the user identified by the identification information indicating “Ricoh Jiro” were not late. In this example, the modification unit 240 modifies the time information before modification associated with the identification information indicating “Ricoh Jiro” to “9:00 a.m. Sep. 16, 2013” which is the working start time. FIG. 11 is a view illustrating information stored in the attendance information storage unit 210 after the modification.

Alternatively, the modification unit 240 can modify the time indicated by the time information before modification associated with the identification information indicating “Ricoh Jiro” by setting back the time by a length of time indicated by the delay time information of FIG. 10. For example, “9:15 a.m.” indicated by the time information before modification associated with the identification information indicating “Ricoh Jiro” is set back by 40 minutes which is the maximum delay time, whereby the time indicated by the time information after modification can be set to “8:35 a.m.”.

Further, for example, a configuration may be possible in which the modification unit 240 can perform the above modification only when the transportation facility indicated by the first transportation facility information associated with the identification information of the authenticated user coincides with the transportation facility indicated by the second transportation facility information included in the delay information. For example, the modification unit 240 identifies, from among the first transportation facility information previously registered in the second retaining unit 220, the first transportation facility information associated with the identification information included in the modification information received from the MFP 1 and performs the modification only when the public transportation facility indicated by the identified first transportation facility information coincides with the public transportation facility indicated by the second transportation facility information included in the modification information. When the determination result is negative, the modification unit 240 does not perform the modification. In this case, the modification unit 240 can request the MFP 1 to display, on the operation panel 27, information indicating that the modification is not performed.

As described above, according to the present embodiment, it is possible to record arrival time/leaving time while automatically reflecting delay of the transportation facility that the user uses.

While the embodiment according to the present invention has been described, the present invention is not limited thereto, but can be embodied by modifying the constituent elements in a practical stage without departing from the scope of the invention. In addition, suitable combination of constituent elements disclosed in the embodiment can form various inventions. For example, some constituent elements can be removed from the whole constituent elements disclosed in the embodiment.

### Modifications

Modifications of the present invention will be described below. The following modifications can arbitrarily be combined with each other. Further, the following modifications can arbitrarily be combined with the above embodiment.

### First Modification

As another embodiment of the information processing system according to the present invention, the delay information may be acquired without use of the scanner function. For example, as illustrated in FIG. 12, the MFP 1 may further include a third retaining unit 170. The third retaining unit 170 retains, for each one or more identification information, specification information (URL, etc.) that can identify an external device that retains information related to an operation state of a transportation facility (transportation facility indicated by the previously registered first transportation facility information) that the user identified by the identification information uses in an associate manner. In the example of FIG. 12, when the user is authenticated by the authentication unit 130, the delay information acquisition unit 150 acquires, from the external device (server, etc.) specified by the specification information associated with the identification information of the authenticated user, the delay information including at least the delay time information indicating the delay time of the transportation facility. Then, as in the above embodiment, the second controller 160 performs control to transmit, to the attendance management server 2, modification information associating the identification information of the authenticated user and delay information acquired by the delay information acquisition unit 150. The functions of the attendance management server 2 are the same as those in the above embodiment.

In this case, the information processing system according to the present invention may include the identification information acquisition unit, first retaining unit, authentication unit, registration controller, third retaining unit, delay information acquisition unit, and modification unit. The identification information acquisition unit acquires the identification information that identifies the user. The first retaining unit retains one or more pieces of identification information for identifying users previously registered. The authentication unit authenticates the user identified by the identification information acquired by the identification information acquisition unit when there exists, among one or more pieces of identification information retained in the first retaining unit, the identification information acquired by the identification information acquisition unit. The registration controller performs control to register the attendance information associating at least the identification information of the authenticated user and time information indicating the time modified by the modification unit. The third retaining unit retains, for each piece of identification information, specification information which can specify an external device that retains information related to an operation state of a transportation facility that the user identified by the identification information uses in an associate manner. The delay information acquisition unit acquires, when the user is authenticated by the authentication unit, the delay information including at least the delay time information indicating the delay time of the transportation facility from the external device specified by the specification information associated with the identification information of the authenticated user. The modification unit modifies, based on the identification information of the authenticated user and the modification information associated with the delay information, the time information included in the attendance information corresponding to the identification information included in the modification information.

### Second Modification

For example, the identification information acquisition unit 110, first retaining unit 120, authentication unit 130, first controller 140, delay information acquisition unit 150, and second controller 160 exemplified as the functions that the MFP 1 has may arbitrarily be implemented in the main body 10 and operation unit 20 in a distributed manner.

Further, for example, the identification information acquisition unit 110, first retaining unit 120, authentication unit 130, first controller 140, delay information acquisition unit 150, second controller 160, attendance information storage unit 210, second retaining unit 220, registration controller 230, and modification unit 240 exemplified as the functions that the MFP 1 and attendance management server 2 have respectively may arbitrarily be implemented in the MFP 1 and attendance management server 2 in a distributed manner.

### Third Modification

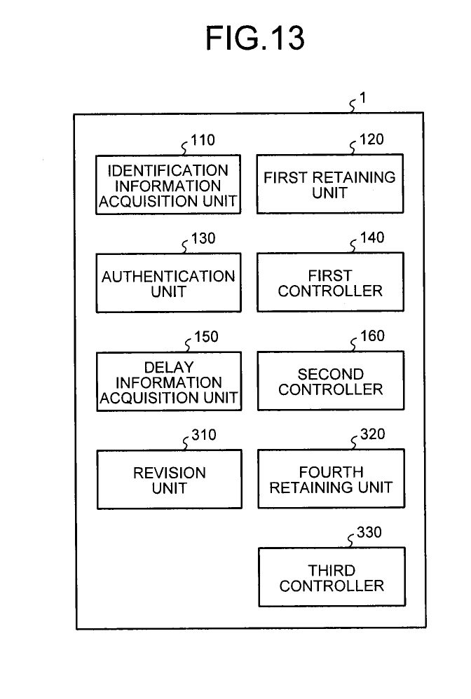

For example, as illustrated in FIG. 13, the MFP 1 may further include a revision unit 310, a fourth retaining unit 320, and a third controller 330. The other configurations are the same as those of the above embodiment, and detailed descriptions thereof will be omitted.

The revision unit 310 revises the delay information acquired by the delay information acquisition unit 150. More specifically, the revision unit 310 revises the delay information according to an instruction from the authenticated user. The fourth retaining unit 320 retains the delay information revised by the revision unit 310 and revision information indicating that the revision has been made by the revision unit 310 in association with each other. The third controller 330 transmits, to the attendance management server 2 including the modification unit 240, second modification information associating the identification information of the authenticated user, delay information revised by the revision unit 310, and revision information. The modification unit 240 of the attendance management server 2 modifies, based on the second modification information (in this example, second modification information associating the identification information of the authenticated user, delay information revised by the revision unit 310, and revision information) associating at least the identification information of the authenticated user and delay information revised by the revision unit 310, the time information included in the attendance information corresponding to the identification information included in the second modification information.

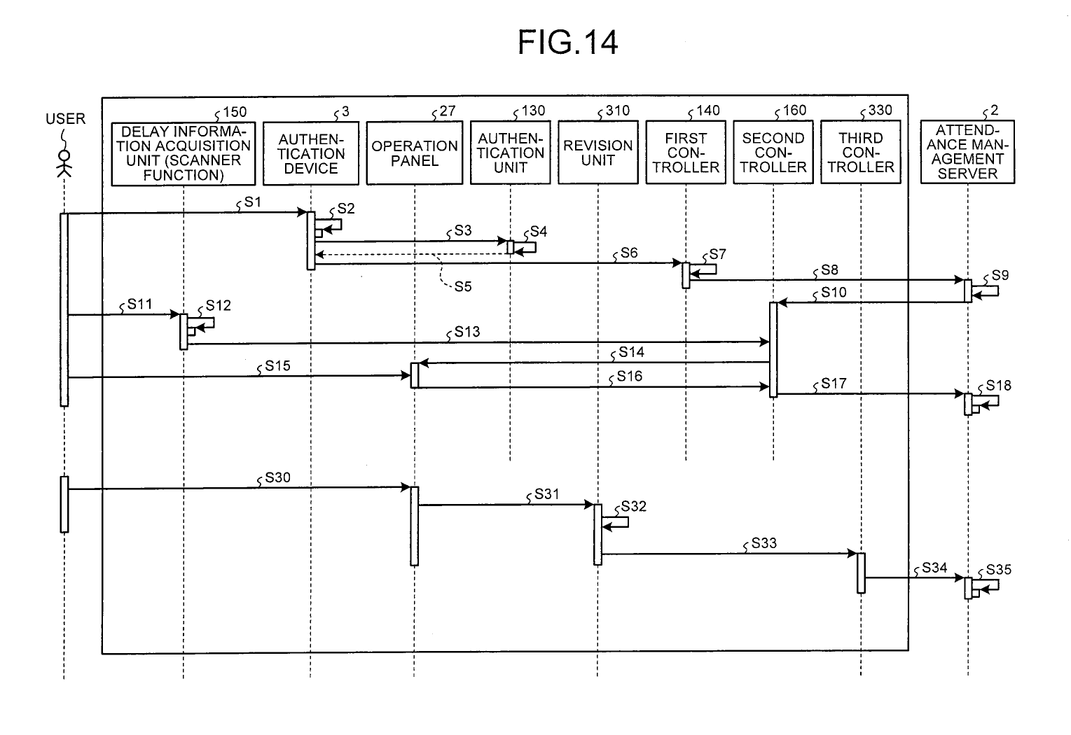

FIG. 14 is a sequence diagram illustrating an example of an operation procedure of the information processing system 100 according to the present modification. The operation procedure from step S1 to step S18 is the same as that in the above embodiment, and detailed descriptions thereof will be omitted. When there is any mistake in the delay information displayed on the operation panel 27 in step S15, the authenticated user depresses an UI button of “NG” of FIG. 10 (step S30). Upon receiving the depression of the UI button of “NG”, the operation panel 27 displays information prompting the user to revise the delay information and notifies the revision unit 310 of reception of the depression of the UI button of “NG” (step S31). Thereafter, the revision unit 310 revises the delay information according to an instruction that the user inputs on the operation panel 27 (step S32) and makes the fourth retaining unit 320 retain the revised delay information and revision information in an associated manner. Then, the revision unit 310 requests the third controller 330 to transmit, to the attendance management server 2, the second modification information associating the identification information of the authenticated user, revised delay information, and revision information (step S33). Upon receiving the request, the third controller 330 performs control to transmit the second modification information to the attendance management server 2 (step S34). Upon receiving the second modification information from the MFP 1, the attendance management server 2 modifies, based on the received second modification information, the time information included in the attendance information corresponding to the identification information included in the second modification information (step S35). More specifically, the modification unit 240 identifies, from among one or more pieces of attendance information stored in the attendance information storage unit 210, attendance information including the identification information included in the second modification information received from the MFP 1. Then, based on the revised delay information included in the second modification information received from the MFP 1, the modification unit 240 modifies the time information included in the identified attendance information.

### Fourth Modification

In the above embodiment, the main body 10 and operation unit 20 operate independently of each other on different operating systems; however, the main body 10 and operation unit 20 may operate on the same operating system.

A program that is executed by the MFP 1 or attendance management server 2 in the above embodiment may be recorded and provided in a computer-readable recording medium such as a CD-ROM, a flexible disk (FD), a CD-R, a DVD (Digital Versatile Disk), or a USB (Universal Serial Bus) as files in an installable form or executable form, or provided or distributed over a network such as the Internet. The various programs may be incorporated beforehand into a non-volatile recording medium such as a ROM, and be then provided.

According to the embodiments described above, it is possible to record arrival time/leaving time while automatically reflecting delay of the transportation facility that the user uses.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
an information processing device;
a server device configured to retain information related to attendance/leaving of a user;
an identification information acquisition unit configured to acquire identification information for identifying the user;
a first retaining unit configured to retain one or more pieces of identification information for identifying users previously registered;
an authentication unit configured to authenticate the user identified by the identification information acquired by the identification information acquisition unit when the pieces of identification information retained in the first retaining unit include the identification information acquired by the identification information acquisition unit;
a registration controller configured to register attendance information in which the identification information of the authenticated user and time information indicating an authentication time are associated with each other when the user is authenticated by the authentication unit;
a delay information acquisition unit configured to read out information of a delay certificate according to an instruction from the authenticated user to acquire delay information including delay time information indicating a delay time; and
a modification unit configured to modify, based on modification information in which the identification information of the authenticated user and the delay information are associated with each other, the time information included in the attendance information corresponding to the identification information included in the modification information.

2. The information processing system according to claim 1, further comprising a second retaining unit configured to retain, for each piece of identification information, first transportation facility information indicating a transportation facility to be used, wherein
the delay information further includes second transportation facility information indicating a delayed transportation facility, and
the modification unit modifies the time information when the transportation facility indicated by the first transportation facility information associated with the identification information of the authenticated user coincides with the transportation facility indicated by the second transportation facility information included in the delay information.

3. The information processing system according to claim 2, further comprising a display controller configured to display the delay information on a display unit.

4. The information processing system according to claim 1, further comprising a revision unit configured to revise the delay information, wherein
the modification unit modifies, based on second modification information in which the identification information of the authenticated user and the delay information revised by the revision unit are associated with each other, the time information included in the attendance information corresponding to the identification information included in the second modification information.

5. The information processing system according to claim 4, further comprising a fourth retaining unit configured to retains the delay information revised by the revision unit revision information indicating that revision has been made by the revision unit such that the delay information and the revision information are associated with each other.

6. The information processing system according to claim 5, further comprising a third controller configured to transmit, to the server device including the modification unit, the second modification information in which the identification information of the authenticated user, the delay information revised by the revision unit, and the revision information are associated with each other.

7. An information processing device comprising:
an identification information acquisition unit configured to acquire identification information for identifying a user;
a first retaining unit configured to retain one or more pieces of identification information for identifying users previously registered;
an authentication unit configured to authenticate the user identified by the identification information acquired by the identification information acquisition unit when the pieces of identification information retained in the first retaining unit include the identification information acquired by the identification information acquisition unit;
a first controller configured to transmit, when the user is authenticated by the authentication unit, to a server device that retains information related to attendance/leaving of the user, attendance information in which the identification information of the authenticated user and time information indicating an authentication time are associated with each other;
a delay information acquisition unit configured to read out information of a delay certificate according to an instruction from the authenticated user to acquire delay information including delay time information indicating a delay time; and
a second controller configured to transmit, to the server device, modification information in which the identification information of the authenticated user and the delay information are associated with each other.

8. An information processing method executed by an information processing device, comprising:
acquiring identification information for identifying a user;
authenticating the user identified by the identification information when one or more pieces of identification information for identifying users previously registered include the identification information acquired at the acquiring, the pieces of identification information being retained in a first retaining unit;
transmitting, when the user is authenticated at the authenticating, to a server device that retains information related to attendance/leaving of the user, attendance information in which the identification information of the authenticated user and time information indicating an authentication time are associated with each other;
reading out information of a delay certificate according to an instruction from the authenticated user to acquire delay information including delay time information indicating a delay time; and
transmitting, to the server device, modification information in which the identification information of the authenticated user and the delay information are associated with each other.
